(19) United States
(12) Patent Application Publication
(10) Pub. No.: US 2017/0120888 A1
(43) Pub. Date: May 4, 2017

(54) VEHICLE CONTROL DEVICE

(71) Applicant: Toyota Jidosha Kabushiki Kaisha, Toyota-shi Aichi-ken (JP)

(72) Inventor: Kunihiko Jinno, Toyota-shi Aichi-ken (JP)

(21) Appl. No.: 15/333,701

(22) Filed: Oct. 25, 2016

(30) Foreign Application Priority Data
Oct. 28, 2015 (JP) 2015-211913

(51) Int. Cl. B60W 20/00; B60W 10/08; B60L 11/18; B60W 10/06

(52) U.S. Cl. CPC B60W 20/00; B60W 10/06; B60W 10/08; B60L 11/1809; B60W 2550/00; B60W 2710/244; B60W 2550/12

(57) ABSTRACT

A vehicle control device mounted on a hybrid vehicle that includes an engine, a motor, and a secondary battery for supplying power to the motor and that is capable of charging the secondary battery using electromotive force generated by the engine. This vehicle control device includes a target setting unit that sets a target charging rate of the secondary battery and a prediction unit that, on a traveling route of a host vehicle, acquires a parking point where it is predicted that a parking time will become longer than a predetermined threshold. The target setting unit is configured to change a setting of the target charging rate, when the host vehicle arrives at a point-before-parking-point that is a predetermined distance before the predicted parking point, to a value smaller than a basic target charging rate that is a target charging rate before the host vehicle arrives at the point-before-parking-point.

### CROSS-REFERENCE TO RELATED APPLICATIONS

The present disclosure claims priority to Japanese Patent Application No. 2015-211913 filed on Oct. 28, 2015, which is incorporated herein by reference in its entirety including the specification, drawings and abstract is incorporated herein by reference in its entirety.

### BACKGROUND

1. Technical Field

The present disclosure relates to a charging technology for a hybrid vehicle.

2. Description of Related Art

A hybrid vehicle has two types of driving force, one is generated by the engine and the other by the motor. The motor converts the electric energy of the battery (secondary battery) to driving force. The engine can not only provide driving force but also charge the battery. The battery can also be charged by the regenerative power of the motor.

A large change in the State of Charge (SOC) of the battery results in a battery deterioration. Therefore, the lower limit value and the upper limit value are usually set for the SOC to control charge and discharge so that the SOC falls within the range from the upper limit value to the lower limit value (hereinafter called “allowable range”).

A hybrid vehicle actively drives the engine at start time for warming up the engine. In the description below, such traveling in the engine traveling mode, during which the engine is warmed up, is called “cold traveling”. When the engine is sufficiently warmed up, in other words, when the cold traveling is completed, the vehicle travels in the normal traveling mode from that time on while maintaining the balance of driving force between the engine and the motor.

The hybrid vehicle disclosed in Japanese Patent Application Publication No. 2014-221576 (JP 2014-221576 A) charges the battery simultaneously and in parallel with engine warm-up by rotating the motor during cold traveling using a part of the engine driving force. In the description below, charging the battery using an engine driving force during cold traveling is called “cold charging”.

### SUMMARY

However, if the SOC is already large enough when cold traveling is started, the cold charging effect is limited. For example, if the SOC has already reached the target charging rate, there is no room for performing cold charging. Therefore, to fully benefit from the cold charging effect, it is desirable that the SOC be lowered, at least sufficiently lower than the target charging rate, when cold traveling is started.

The present disclosure provides a technology for allowing a hybrid vehicle to increase the usage efficiency of cold charging.

A vehicle control device in an aspect of the present disclosure is a vehicle control device mounted on a hybrid vehicle that includes an engine, a motor, and a secondary battery for supplying power to the motor and that is capable of charging the secondary battery using electromotive force generated by the engine. This vehicle control device includes a target setting unit configured to set a target charging rate of the secondary battery and a prediction unit configured to, on a traveling route of a host vehicle, acquire a parking point where it is predicted that a parking time will become longer than a predetermined threshold. The target setting unit is configured to change a setting of the target charging rate, when the host vehicle arrives at a point-before-parking-point that is a predetermined distance before the predicted parking point, to a value smaller than a basic target charging rate that is a target charging rate before the host vehicle arrives at the point-before-parking-point.

According to the above aspect, the battery charging efficiency during cold traveling is easily increased.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a schematic diagram showing cold charging;

FIG. 2 is a functional block diagram showing a vehicle control system in a first embodiment;

FIG. 3 is a schematic diagram showing a route prediction method;

FIG. 4 is a graph showing the frequency distribution of parking times at point B;

FIG. 5 is a graph showing the frequency distribution of parking times at point E;

FIG. 6 is a sequence diagram showing the processing sequence of destination prediction;

FIG. 7 is a flowchart showing the control process of the target charging rate; and

FIG. 8 is a functional block diagram showing a vehicle control system in a second embodiment.

### DETAILED DESCRIPTION OF EMBODIMENTS

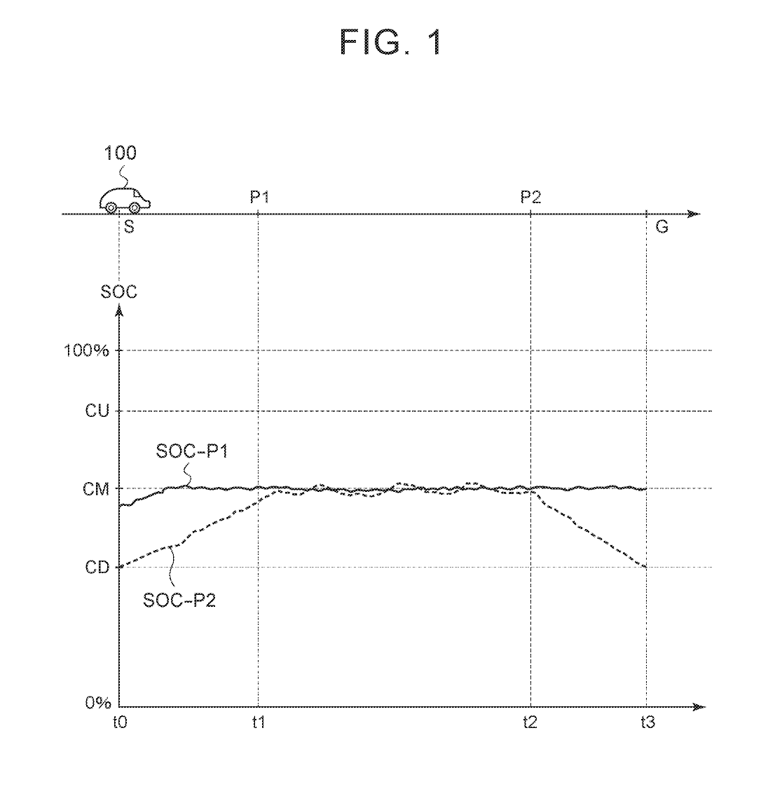

FIG. 1 is a schematic diagram showing cold charging. It is assumed that a vehicle 100 starts at point S at time t0, arrives at point P1 at time t1, arrives at point P2 at time t2, and arrives at point G at time t3. Point S is the start point, and point G is the destination. It is also assumed that the interval from point S to point P1 is the interval of cold traveling (hereinafter simply called “cold interval”). The top half of FIG. 1 indicates the traveling route of the vehicle 100. The bottom half of FIG. 1 shows a change in the State of charge (SOC) (charging rate of the battery). The minimum value of the SOC is 0%, and the maximum value is 100%. An allowable range is set for the SOC. The allowable range is defined by the lower limit value CD and the upper limit value CU. It is assumed that the lower limit value CD is about 40% and the upper limit value CU is about 80%.

The target charging rate is set within this allowable range. The target charging rate is set, for example, to about 65%. In the description below, the target charging rate during normal traveling time is called a “basic target charging rate”. The basic target charging rate in this embodiment is assumed to be 65%. Two types of cold charging methods are described below. One is a method in which the target charging rate is fixed at the basic target charging rate (standard method), and the other is a method in which the target charging rate is variable (this method is used in this embodiment).

(1) When the target charging rate is fixed, the target charging rate is fixed at the basic target charging rate CM between the lower limit value CD and the upper limit value CU. The change in the SOC in this method is indicated by SOC-P1. As shown in FIG. 1, the battery is charged and discharged so that SOC-P1 is maintained around the basic target charging rate CM. After starting at point 5, the vehicle 100 travels in the cold traveling mode, that is, in the engine traveling mode, for some time. During this time, the engine rotates not only the tires but also the motor. Because the motor functions as an electric generator, the battery can be charged in the cold charging mode. If the SOC is lower than the target charging rate (basic target charging rate CM), the battery is charged in the cold charging mode. In the case shown in FIG. 1, because SOC-P1 is near the basic target charging rate CM when the vehicle 100 starts at point S at time t0, this method cannot fully benefit from the cold charging effect.

(2) When the target charging rate is variable, the target charging rate is set at the basic target charging rate CM between the lower limit value CD and the upper limit value CU at point S in the same way as in the case described in (1). The difference is that, at point S, the SOC is lowered to a point near the lower limit value CD. The method for lowering the SOC at point S will be described in detail later. The change in the SOC in this method is indicated by SOC-P2. As shown in FIG. 1, the battery is also charged and discharged so that SOC-P2 is maintained around the basic target charging rate CM. After the vehicle 100 starts at point S, SOC-P2 is raised in the cold charging mode until it reaches the basic target charging rate CM. Because the SOC at the start time is sufficiently lower than the basic target charging rate CM, this method can fully benefit from the cold charging effect. In addition, the cold charging increases the load on the engine, resulting in an additional effect of facilitating engine warmup. As a result, this method makes the cold interval shorter than that when the method in (1) is used.

Setting SOC-P2 sufficiently lower at point S requires a technology for predicting the next cold-traveling start point, that is, the destination. To satisfy this requirement, the vehicle 100 uses the method, which will be described later, to predict point G (destination) and lowers the target charging rate to a point near the lower limit value CD at point P2 that is a predetermined distance before point G. The target charging rate at this time is called a “special target charging rate”. Point P2 is called a “discharge point”.

In summary, the vehicle 100 predicts point G (destination) during traveling, and sets discharge point P2 at a point that is a predetermined distance before point G. When the vehicle 100 arrives at the discharge point P2, the target charging rate is lowered from the basic target charging rate to the special target charging rate. Because the electric energy is actively used as driving force after the discharge point P2, SOC-P2 is rapidly lowered. As a result, when the vehicle 100 arrives at point G, SOC-P2 is lowered to a point near the lower limit value CD. When the vehicle 100 restarts from point G, the target charging rate is reset to the basic target charging rate CM. Because SOC-P2 is lowered to a point near the lower limit value CD at point G, this method can fully benefit from the cold charging effect when the vehicle 100 restarts from point G. The ease of achieving the cold charging effect, as well as a shorter cold interval, can lead to fuel savings.

For proper function of this mechanism, it is necessary to predict point G (destination) accurately. The following describes the technology with emphasis on the destination prediction method.

### First Embodiment

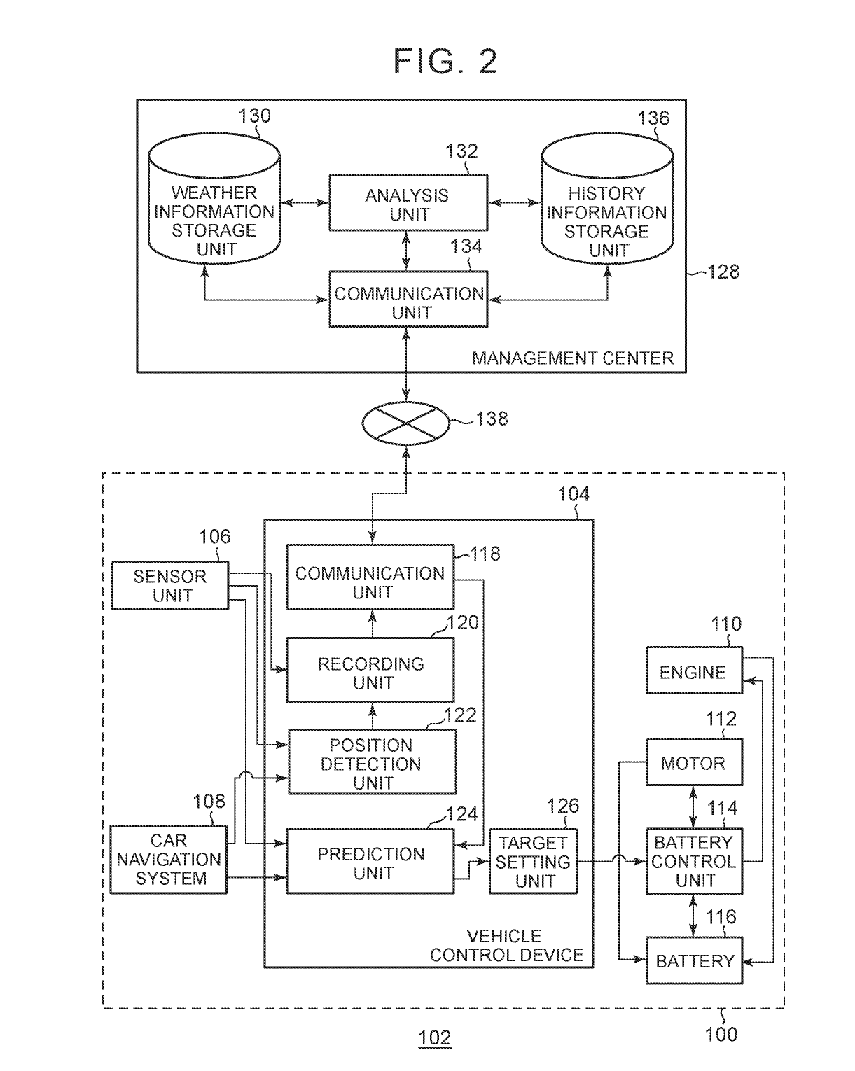

FIG. 2 is a functional block diagram showing a vehicle control system 102 in a first embodiment. The components of the vehicle control system 102 are implemented by the CPU and the memory of a computer, the programs loaded into the memory for implementing the components shown in FIG. 2, a storage unit such as a hard disk in which the programs are stored, and a combination of hardware and software with the network connection interface as its main element. As those skilled in the art understand, there are many variations of implementation methods and devices. The figures referenced in the description below show, not the hardware configurations, but the functional blocks.

In the vehicle control system 102, a vehicle control device 104 and a management center 128 are connected via a communication network 138. The vehicle control device 104 is an electronic apparatus mounted on the vehicle 100. The management center 128 is a server that collects information from each vehicle control device 104, analyses the collected information, and sends an instruction to the vehicle control device 104.

The vehicle control device 104 is connected to a sensor unit 106, a car navigation system 108, and a battery control unit 114. The sensor unit 106 collects information on the external environment and the traveling trajectory of the host vehicle.

The sensor unit 106 may include a steering angle sensor, a yaw rate sensor, a wheel pulse sensor, a radar, and a direction indicator.

A battery 116 is a lithium ion secondary battery (storage battery). The battery control unit 114 controls the SOC of the battery 116 by controlling an engine 110 and a motor 112. The vehicle control device 104 specifies a target charging rate for the battery control unit 114. As described above, the target charging rate is set to the basic target charging rate CM during normal traveling time and, as necessary, to a special target charging rate CD that is lower than the basic target charging rate CM. Each functional block of the vehicle control device 104 in this embodiment is configured by an electronic control unit (ECU) and the software program executed on the ECU.

The vehicle control device 104 includes a communication unit 118, a recording unit 120, a position detection unit 122, a prediction unit 124, and a target setting unit 126. The position detection unit 122 acquires the current position of the vehicle 100 from the sensor unit 106 and the car navigation system 108. The recording unit 120 records, as necessary, the sensed information (hereinafter called “primary information”) such as the vehicle's current position, stop time, start time, and vehicle speed. The stop time is the time at which the instruction to stop the engine 110 is received, and the start time is the time at which the instruction to start the engine 110 is received. The communication unit 118 regularly sends the primary information, which includes the vehicle ID, to the management center 128. The vehicle ID is the information that uniquely identifies the vehicle.

The prediction unit 124 predicts the traveling route of the vehicle 100 based on the vehicle speed information and the steering angle information, obtained from the sensor unit 106, and the route setting information that is set in the car navigation system 108. In addition, the prediction unit 124 identifies the destination based on the information sent from the management center 128. The target setting unit 126 sets the target charging rate. The purpose of the target setting unit 126 is to increase the cold charging effect.

The management center 128 includes a weather information storage unit 130, an analysis unit 132, a communication unit 134, and a history information storage unit 136. The communication unit 134 regularly receives the primary information from the vehicle control device 104. The analysis unit 132 processes the primary information to generate “secondary information” and records the generated secondary information in the history information storage unit 136. The secondary information includes the information on parking. That is, the secondary information is the information that indicates the parking date/time (time zone and day of week), parking time, and parking point of the vehicle 100. The history information storage unit 136 stores the traveling history information (secondary information) on each vehicle with the vehicle ID associated with the traveling history information. The weather information storage unit 130 stores the weather information, especially, the weather information indicating the forecast temperature at each point. The analysis unit 132 predicts the destination of the vehicle 100 based on the traveling history information (secondary information), stored in the history information storage unit 136, and the weather information. The prediction method will be described in detail later. The communication unit 134 returns the destination back to the vehicle control device 104.

The vehicle 100 in the first embodiment works with the management center 128 to predict the destination. In this embodiment, “parking” refers to “the state in which the engine 110 of the vehicle 100 is stopped”. In addition, “parking” is divided roughly into two: one is “short-time parking” in which the engine 110 is not cooled much or, in other words, cold traveling is either not required or not so much required, and the other is “long-time parking” in which sufficient cold traveling is required. More specifically, parking is classified into long-time parking in which the parking time is longer than the threshold (hereinafter called “parking threshold”) and short-time parking in which the parking time is shorter than the threshold. In this embodiment, the parking threshold is six hours. As will be described later, it should be noted that the parking threshold is variable according to the weather information. A point where the vehicle is parked, or will be parked, in the short-time parking mode is called a “via-point”, and a point where the vehicle is parked, or will be parked, in the long-time parking mode is called a “destination”.

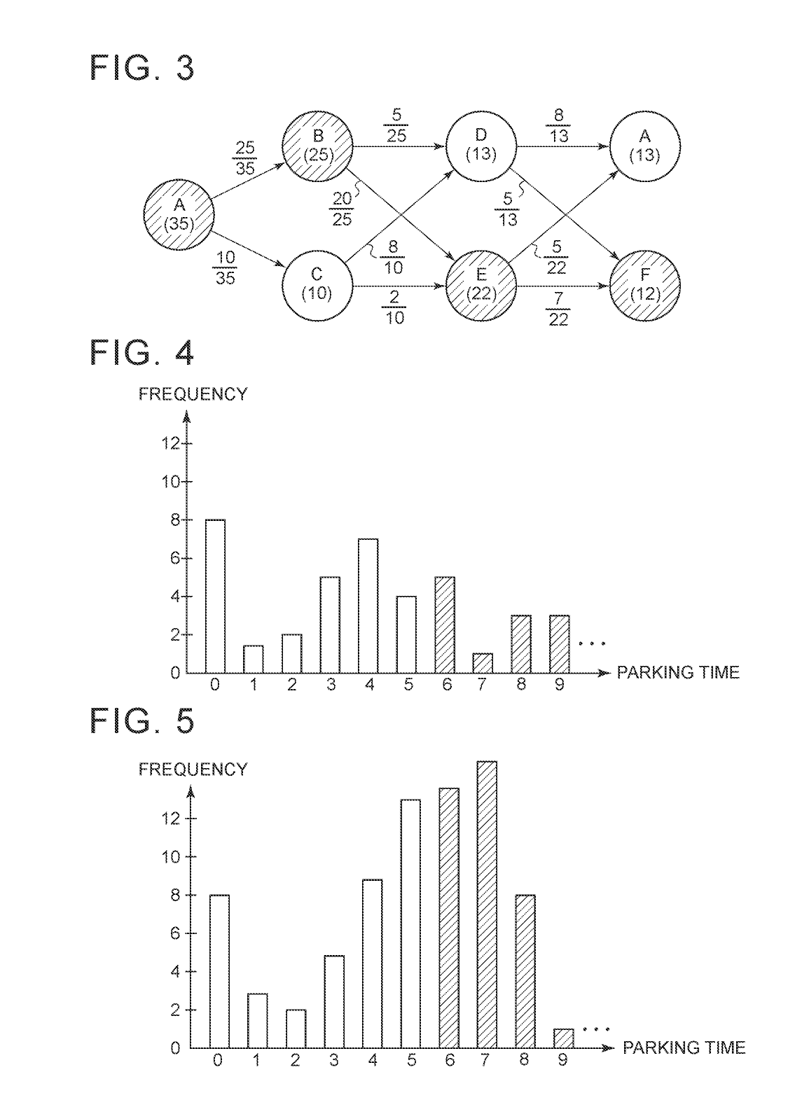

FIG. 3 is a schematic diagram showing the route prediction method. The history information storage unit 136 stores traveling history information on each vehicle 100. The traveling history information (secondary information) includes information on the parking of the vehicle (date/time, location, and parking time). The traveling history information, shown in FIG. 3, indicates that the vehicle 100 was parked at point A thirty-five times in the past. The thirty-five times of parking includes both short-time parking and long-time parking. The vehicle 100, which left point A, travelled toward point B twenty-five times out of thirty-five times, and toward point C ten times. Therefore, the analysis unit 132 predicts that, when the vehicle 100 is parked at point A, the vehicle 100 is most likely to travel toward point B.

The vehicle 100 was parked at point B twenty-five times in the past and, after that, travelled toward point E twenty times, and toward point D the remaining five times. According to the prediction method described above, it is predicted that, when the vehicle 100 is parked at point A, the vehicle will be parked in the order of points B, E, and F. In this manner, the analysis unit 132 predicts the most probable traveling route based on the traveling history information. Next, the analysis unit 132 identifies whether each of points B, E, and F is a via-point where the vehicle will be parked for a short time or a destination where the vehicle will be parked for a long time.

In the description below, it is assumed that the vehicle 100 starts at point A at 13:30 on Tuesday. It is also assumed that the analysis unit 132 has predicted that the vehicle will arrive at points B, E, and F at 14:00, 15:00, and 16:00, respectively, based on the distance from point A to points B, E, and F.

FIG. 4 is a graph showing the frequency distribution of parking times at point B. More specifically, FIG. 4 shows the distribution of parking times when the vehicle 100 was parked at point B in a time zone before and after 14:00 (for example, 13:30-14:30) on Tuesday. For example, when the vehicle 100 was parked in this time zone in the past, the number of times the vehicle 100 was parked for a duration of three hours (equal to or longer than three hours and shorter than four hours) is five. The traveling history information shown in FIG. 4 indicates that the most frequent value of the parking times when the vehicle 100 was parked in the time zone before and after 14:00 on Tuesday is four hours (equal to or longer than four hours and shorter than five hours). That is, when the vehicle 100 starts at point A at 13:30 on Tuesday, there is a high possibility that the vehicle 100 will be parked at point B at 14:00. At that time, because the predicted parking time is four hours that is shorter than the parking threshold of six hours, it is predicted that the vehicle 100 will be parked in the short-time parking mode. Using the process described above, the analysis unit 132 determines that point B is not a destination but a via-point. Because the vehicle 100 is parked at point B in the short-time parking mode, the engine 110 is not cooled much with the result that the cold interval after the vehicle 100 starts at point B becomes short. In this case, sufficient cold charging is not expected and, therefore, the target charging rate is not lowered at a point before point B.

FIG. 5 is a graph showing the frequency distribution of parking times at point E. More specifically, FIG. 5 shows the distribution of parking times when the vehicle 100 was parked at point E in a time zone before and after 15:00 (for example, 14:30-15:30) on Tuesday. As shown in FIG. 5, the most frequent value of the parking times when the vehicle 100 was parked in the time zone before and after 15:00 on Tuesday in the past is seven hours (equal to or longer than seven hours and shorter than eight hours). That is, when the vehicle 100 starts at point A at 13:30 on Tuesday, there is a high possibility that the vehicle 100 will be parked at point E at 15:00. At that time, because the predicted parking time is seven hours that is longer than the parking threshold of six hours, it is predicted that the vehicle 100 will be parked in the long-time parking mode. Using the process described above, the analysis unit 132 determines that point E is a destination. Because the vehicle 100 is parked at point E in the long-time parking mode, the engine 110 is cooled sufficiently. Because the cold interval after the vehicle 100 starts at point E becomes long, sufficient cold charging is expected. Therefore, a discharge point is set at a point before point E. When the vehicle 100 arrives at the discharge point, the target charging rate is lowered.

As described above, when the vehicle 100 is positioned at point A, point E is identified as a destination based on the traveling history information and a point, which is a predetermined distance from point E in the traveling route (for example, five kilometers before point E) is set as the discharge point. However, it should be noted that the above description is based on the prediction and that the vehicle 100 will not always travel as predicted. For example, when the vehicle 100 starts at point A and, after that, travels toward point C instead of point B, the predicted traveling route is changed to the route composed of points C, D, and A (see FIG. 3). In this case, the analysis unit 132 identifies the destination from points C, D, and A in the similar manner, and the target setting unit 126 re-sets the discharge point.

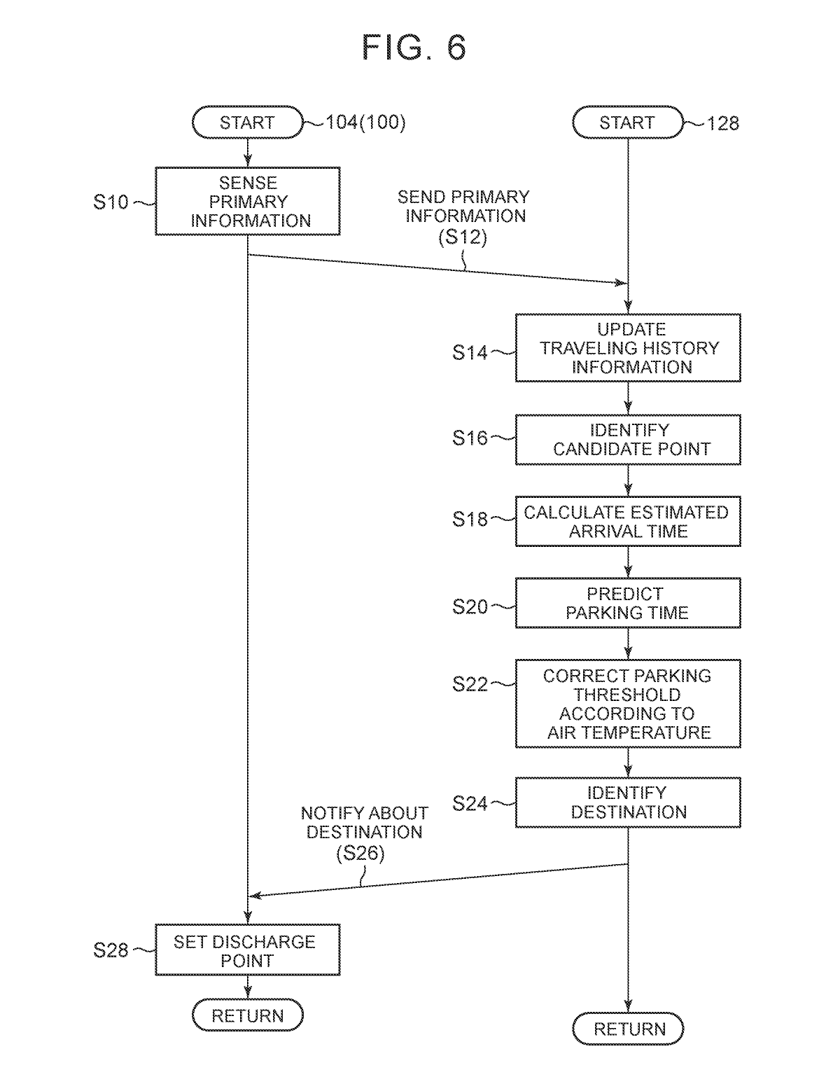

FIG. 6 is a sequence diagram showing the processing sequence of destination prediction. The processing shown in FIG. 6 is loop processing that is repeated at regular intervals, for example, at intervals of several minutes. The position detection unit 122 acquires the current position from the sensor unit 106 and the car navigation system 108 (S10). At this time, the recording unit 120 also acquires the vehicle speed as well as the stop time and the start time if the vehicle 100 stopped and then started. The recording unit 120 records the information sensed as the primary information. The communication unit 118 adds the vehicle ID to the primary information and sends the primary information to the management center 128 (S12).

When the communication unit 134 of the management center 128 receives the primary information, the analysis unit 132 updates the traveling history information (secondary information) stored in the history information storage unit 136 (S14). For example, when the information indicating the stop time is received and, after that, the information indicating the start time is received, the analysis unit 132 identifies the time from the stop time to the start time as the parking time. Using the parking time identified in this manner, the frequency distribution information such as that shown in FIGS. 4 and 5 is updated. In addition, when parking is detected, the analysis unit 132 updates the traveling frequency from the previous parking point to the current parking point. Using the information on the traveling frequency updated in this manner, the traveling route information shown in FIG. 3 is updated.

The analysis unit 132 predicts the parking points after the current position, based on the current position of the vehicle 100 and the traveling route prediction information shown in FIG. 3 (S16). In this way, the analysis unit 132 identifies one or more parking points as the candidates for the destination. The analysis unit 132 calculates the estimated time at which the vehicle will arrive at each candidate point (S18). The estimated arrival time can be calculated using the algorithm similar to that used by the car navigation system 108.

The analysis unit 132 predicts the parking time at each candidate point using the method described by referring to FIGS. 4 and 5 (S20). Although six hours in this embodiment, the parking threshold, according to which the parking is classified into short-time parking and long-time parking, may be adjusted according to the outside air temperature. For example, because the engine 110 is sufficiently cooled in the winter even when the parking time is as short as three hours, sufficient cold traveling is required when the vehicle 100 is restarted. To address this problem, if the estimated temperature at the estimated arrival time of a candidate point is lower than a predetermined temperature threshold (for example, 5° C.), the analysis unit 132 lowers the parking threshold from six hours to two hours. In this way, the analysis unit 132 corrects the parking threshold according to the estimated outside air temperature (S22). The estimated temperature of each point is saved in the weather information storage unit 130 as the weather information. The management center 128 may acquire the weather information from the meteorological bureau, for example. The analysis unit 132 identifies the first candidate point, where the vehicle 100 is predicted to park longer than the parking threshold, as the destination (S24).

The communication unit 134 of the management center 128 notifies the vehicle control device 104 about the predicted destination as well as via-points (S26). The prediction unit 124 predicts the traveling route based on the via-points and the destination and sets a discharge point at a point a predetermined distance before the destination (S28).

The processing shown in FIG. 6 is regularly executed. Therefore, before the vehicle 100 arrives at the destination, the predicted destination or via-points may be changed. If the destination or via-points are changed, the prediction unit 124 re-sets the discharge point as necessary.

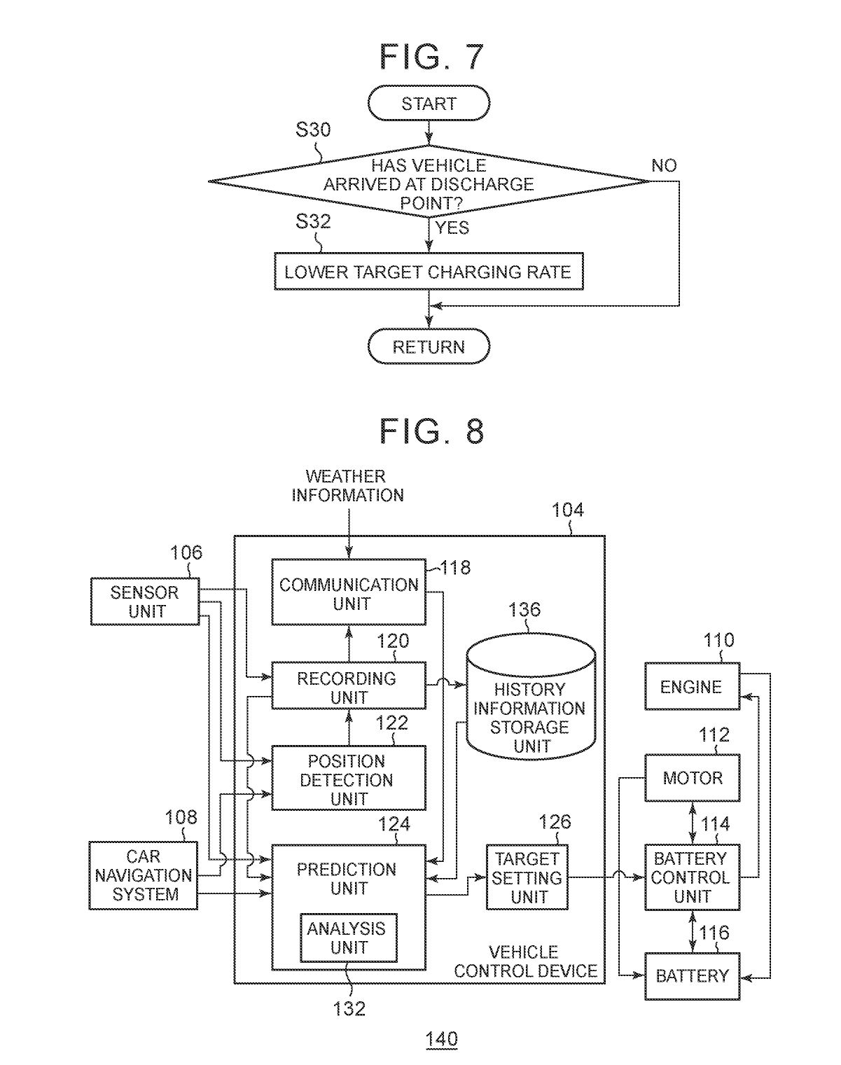

FIG. 7 is a flowchart showing the control process of the target charging rate. The processing shown in FIG. 7 is loop processing that is repeated by the vehicle control device 104 at regular intervals, for example, at intervals of several seconds. The processing in FIG. 7 is executed by the vehicle control device 104 in the standalone mode. The position detection unit 122 regularly detects the current position of the vehicle 100 and determines whether the vehicle 100 has arrived at the discharge point (S30). If the vehicle 100 has arrived at the discharge point (YES in S30), the target setting unit 126 lowers the target charging rate from the basic target charging rate to the special target charging rate (S32). Lowering the target charging rate in this manner causes the battery control unit 114 to lower the SOC with priority on the vehicle driving by electric energy. If the vehicle 100 has not yet arrived at the discharge point (NO in S30), step S32 is skipped. When the engine of the vehicle 100 is started, the target setting unit 126 restores the target charging rate to the basic target charging rate.

### Second Embodiment

FIG. 8 is a functional block diagram showing a vehicle control system 140 in a second embodiment. In the vehicle control system 140 in the second embodiment, a vehicle control device 104 includes the analysis function that is included in the management center 128 in the first embodiment. In addition to a communication unit 118, a recording unit 120, a position detection unit 122, a prediction unit 124, and a target setting unit 126, the vehicle control device 104 includes a history information storage unit 136. The recording unit 120 not only records primary information but also generates traveling history information (secondary information) from the primary information, and records the generated traveling history information in the history information storage unit 136. The communication unit 118 acquires weather information from the meteorological bureau.

The prediction unit 124 predicts the traveling route of the vehicle 100 based on the information from a sensor unit 106 (such as vehicle speed and steering angle) and the route setting information in a car navigation system 108. The prediction unit 124 includes an analysis unit 132. The analysis unit 132 predicts the via-points and destination using the algorithm similar to that in the first embodiment based on the traveling history information and the weather information. The vehicle control device 104 in the second embodiment, which includes the destination prediction function included in the management center 128 in the first embodiment, has a merit that there is no time lag caused by the communication.

The processing process of the vehicle control systems 102 and 140 has been described based on the embodiments. The vehicle control device 104 predicts the via-points and destination of the vehicle 100 by working with the management center 128 or by operating in the standalone mode, and starts lowering the SOC at a point before the destination. This method easily increases the cold charging effect, thus leading to fuel savings. In particular, this method is effective on high-frequency traveling routes, such as the route to and from the office, because the destination can be identified accurately.

The present disclosure has been described based on the embodiments. The embodiments are exemplary only, and it is apparent that those skilled in the art understand that modifications may be created by combining the components or the processing processes of the embodiments and that those modifications are included in the scope of the present disclosure.

What is claimed is:

1. A vehicle control device mounted on a hybrid vehicle, the hybrid vehicle including an engine, a motor, and a secondary battery for supplying power to the motor, the hybrid vehicle being capable of charging the secondary battery using electromotive force generated by the engine, the vehicle control device comprising:
a target setting unit configured to set a target charging rate of the secondary battery; and
a prediction unit configured to, on a traveling route of a host vehicle, acquire a parking point where it is predicted that a parking time will become longer than a predetermined threshold, wherein
the target setting unit is configured to change a setting of the target charging rate to a value smaller than a basic target charging rate when the host vehicle arrives at a point-before-parking-point that is a predetermined distance before the predicted parking point, the basic target charging rate being a target charging rate before the host vehicle arrives at the point-before-parking-point.

2. The vehicle control device according to claim 1, wherein the prediction unit is further configured to acquire a via-point and to set the point-before-parking-point that is before the predicted parking point.

3. The vehicle control device according to claim 1, wherein the target setting unit is configured to set the target charging rate to the basic target charging rate when the engine of the vehicle is started.

4. The vehicle control device according to claim 1, further comprising:
a position detection unit configured to acquire a current position;
a recording unit configured to record sensed primary information; and
a communication unit configured to send the primary information to an external unit and, at a same time, to receive a predicted destination and the predicted parking point from the external unit.

5. The vehicle control device according to claim 1, further comprising:
a position detection unit configured to acquire a current position;
a recording unit configured to record sensed primary information and, at a same time, to generate traveling history information on the vehicle from the primary information;
a history information storage unit configured to store the traveling history information; and
a communication unit configured to receive weather information,
wherein the prediction unit includes an analysis unit configured to predict a via-point and the parking point based on the traveling history information and the weather information.
